(19) United States
(12) Patent Application Publication
(10) Pub. No.: US 2007/0012733 A1
(43) Pub. Date: Jan. 18, 2007

(54) Bite valve retainer

(76) Inventors: Michael Horito, Provo, UT (US); Dennis B. Brown, Logan, UT (US)

Correspondence Address: HOLME ROBERTS & OWEN, LLP, 299 SOUTH MAIN, SUITE 1800, SALT LAKE CITY, UT, 84111, US

(21) Appl. No.: 11/180,115

(22) Filed: Jul. 12, 2005

(51) Int. Cl. A45F 3/16; B67D 5/64; A45F 5/00

(52) U.S. Cl. 224/148.2; 222/175

(57) ABSTRACT

A system for hydration has a back pack that holds a bladder with liquids for consumption by the user. The bladder has an intake port for filling and a discharge port connected to a discharge tube to transmit the fluid to a bite valve. A magnet is attached to the bite valve; and a magnet is attached to a buckle on the straps supporting the back pack. The bite valve has a free position remote from the buckle and a stored position in which the magnet on the bite valve is magnetically attached to a magnet on the buckle. The magnet has sufficient force to draw the bite valve to the buckle when the bite valve is proximate the buckle so that a user need not use a hand to unite the bite valve with the buckle.

### BACKGROUND OF THE INVENTION

1. The Field of the Invention

This invention relates to hydration systems for providing fluids like water upon demand to a user.

2. The Relevant Technology

Personal hydration systems range from what could be regarded as the well known canteen (See one new example in U.S. Des. Patent No. 187,112 (Allenbach)) to bottles to bladders carried on the back of the user much like a back pack; See U.S. Pat. No. 6,032,831 (Gardner, et al). In some versions, a tube extends from the back of the pack to the front with a bite valve on its end which the user places in his/her mouth and operates by biting upon the valve to open and close it. See U.S. Pat. No. 6,039,305 (Hoskins, et all). While retention of the bite valve in the mouth is preferred, some users find it uncomfortable or inconvenient to retain it in the mouth particularly when involved in vigorous exercise or activity. Thus, the bite valve is sometimes removed after use and when so removed is coated with saliva so that contaminants may easily attach to it.

In some known systems, the bite valve out of the mouth is free to move about substantially unrestrained. Examples can be seen in U.S. Pat. No. 6,497,348 (Forsman). Thus in use the bite valve when removed from user's mouth, hangs free, allowing it to bounce or touch the user's clothing. Of course, if and when allowed to swing free, the bite valve can contact other persons, plants, the ground or other substrates or things that can contaminate the bite valve. In other circumstances, the bite valve may become entangled in equipment such as bicycle cables or trapped between the seat and gas tank of a motorcycle, which may separate the valve from the tube and thus unintentionally empty the contents of the hydration system. In such cases, the safety of the user may be compromised by a lack of restraint of the bite valve.

Thus it is desirable that systems be available to hold the bite valve when not in use. Schemes to effect such restraint have been ineffective in holding the bite valve. Clips, clamps, hook and pile connectors and the like have been suggested which all require user manipulation of something mechanical to effect connection or disconnection. However, taking the time and attention to refasten a bite valve to its securing means can have disastrous consequences for activities that require utilizing both hands at all times (e.g. rock climbing, extreme downhill skiing, motocross, kayaking, etc.).

Hence, a hydration system that is not truly a “hands free” system may be dangerous to operate under conditions where a user cannot manually reattach the bite valve to its holding system. Accordingly, there is a need for an improved arrangement to hold the bite valve and reduce its exposure to contamination and/or entanglement. Such an improved arrangement should be easy to operate and not require user manipulation to effect restraint.

### BRIEF SUMMARY OF THE INVENTION

A hydration system provides liquid to a user upon demand. The system includes a support means for removable attachment to the body of a user. A support means can be back pack, a waist belt or other system or structure to removably affix the hydration system to the body so that it is available for a wide range of suitable applications and in performing a wide range of action. The support means has a front portion, such as, for example, the belts or straps of a back pack, for positioning proximate the front or mouth of a user.

The desired hydration system also has container means for retaining fluid therein. Any suitable container configured to retain liquid and configured to be carried by a user is within contemplation. However, the bladder versions depicted are preferred for cost and convenience. The container means is associated with and supported by said support means. Desirably, the support means is some kind of pack structure configured to hold and retain the container means.

The container means has at least one fill-port means arranged for transmitting fluid into and desirably out of the container means. The container means also has a separate discharge port means for transmitting said fluid out of the container means. Also included is transmission means for transmitting the fluid from a proximal end through a length to a distal end. The proximal end is connected to the discharge port means for receiving the fluid from the discharge port means for communication or transmission through its length to its distal end. Bite valve means is connected to the distal end of the transmission means and is configured for positioning in the mouth of the user and operable by biting thereon. It is configured to be operable between a first closed position inhibiting the flow of fluid there though and a second open position in which the fluid passes there through.

The preferred system also includes retaining means for removably retaining the bite valve means to the front portion of the support system. The retaining means has a first element attached to the front portion and a second element attached to the bite valve means. The bite valve out of the user's mouth is movable between a stored position in which the first element and said second element are attracted toward each other and attached and a free position in which the second element is detached from the first element.

In a preferred configuration, the support system is a pack, which may be back pack, a fanny pack or any other pack device for attachment to and/or suspension from and on the body of a user. The container means may be a canteen or preferably a bladder sized to be positioned in the back pack.

Most preferably, the first element of the retaining means is a first magnet and the second element is a second magnet, selected to be attracting toward or with the first magnet. When the bite valve is allowed to swing free the second magnet attached thereto and the first magnet are attracted toward each other such that the first magnet attaches to the second magnet when in proximity. The distance in which the magnetic force is sufficient to attract the first magnet toward the second magnet will vary based on the strength and size of the magnets. Magnets may be selected to have a magnetic field to attract one to the other when spaced apart a distances from up to about 1 inch to about 4 inches. More desirably, the first magnet and the second magnet are selected to be cylindrical in shape and most desirably are rare earth magnets.

In desired configuration, the transmission means is a discharge tube having a length selected to extend over the shoulder of the user to position its distal end proximate the first magnet for movement into the stored position.

In preferred personal hydration systems, the bite valve has a housing and a sleeve sealingly and rotatably positioned in said housing. The first mange is attached to the housing. Preferably, the sleeve includes a head having an aperture. A tooth assembly for positioning in the mouth of the user is inserted into the aperture of the head. Desirably the sleeve is rotatable relative to the housing.

In alternate configurations, the support system is a back pack with a strap that extends over the shoulder. The strap has a length to extend along the front of the body for further extension along the torso toward the back and for reconnection to the back pack. The first element includes a buckle attached and movable along the length of the strap most preferably to a location, so that when the bite valve is not in the user's mouth, it can hang down along the user's front with the bite valve magnetically attaching to the buckle so that the user need not use any hands to effect the attachment.

The buckle desirably includes top belt receptacle and bottom belt receptacle each configured to slidingly receive the strap. Most preferably, each buckle has a perimeter and a first slot extending from the perimeter to the top belt receptacle, and a second slot extending from said perimeter to said bottom belt receptacle. The first slot and second slot both are sized to receive said strap there through. Thus, the buckle can be easily attached to and removed from the strap.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a rear perspective with a portion of a pack cut-away of a hydration system of the present invention;

FIG. 2 is a front perspective of a hydration system of the present invention;

FIG. 3 is a perspective of a bladder for use in a hydration system of the present invention;

FIG. 4 is a front perspective of a buckle for use on a strap of a pack of a hydration system of the present invention;

FIG. 5 is a partial enlargement of portions of the buckle of FIG. 4;

FIG. 6 depicts a magnet for use on the buckle of FIG. 4;

FIGS. 7-12 are various views and cross sections of an alternate buckle for use with the hydrations system of the present invention;

FIG. 13 depicts a bite valve attached to a buckle of a hydration system; and

FIG. 14. depicts the bite valve of FIG. 13 exploded to show the magnet attached thereto.

### DESCRIPTION OF A PREFERRED EMBODIMENT

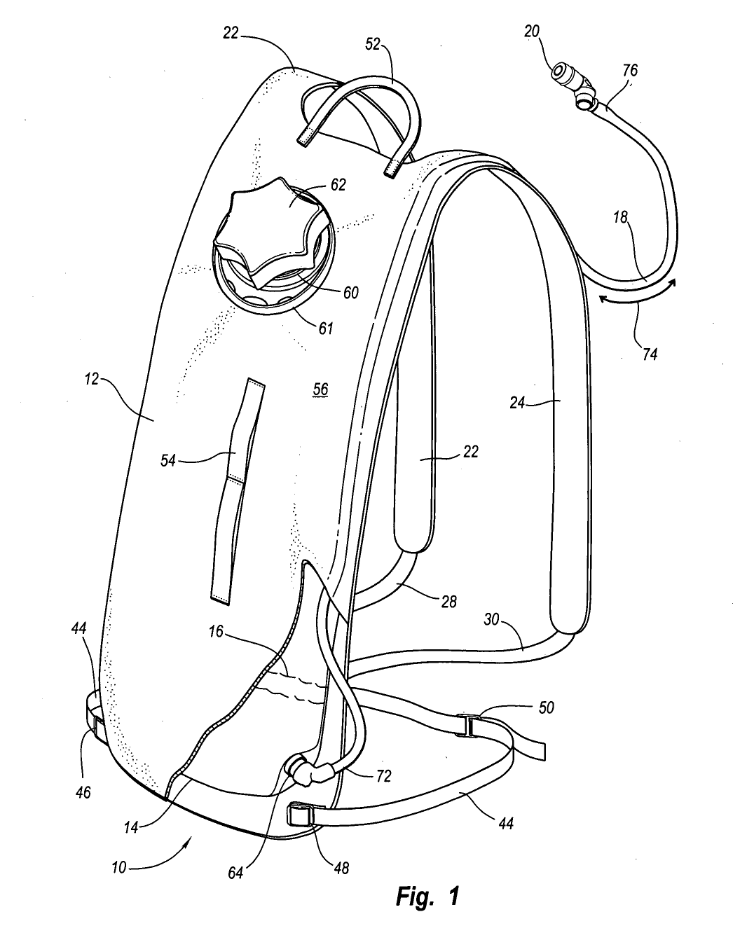

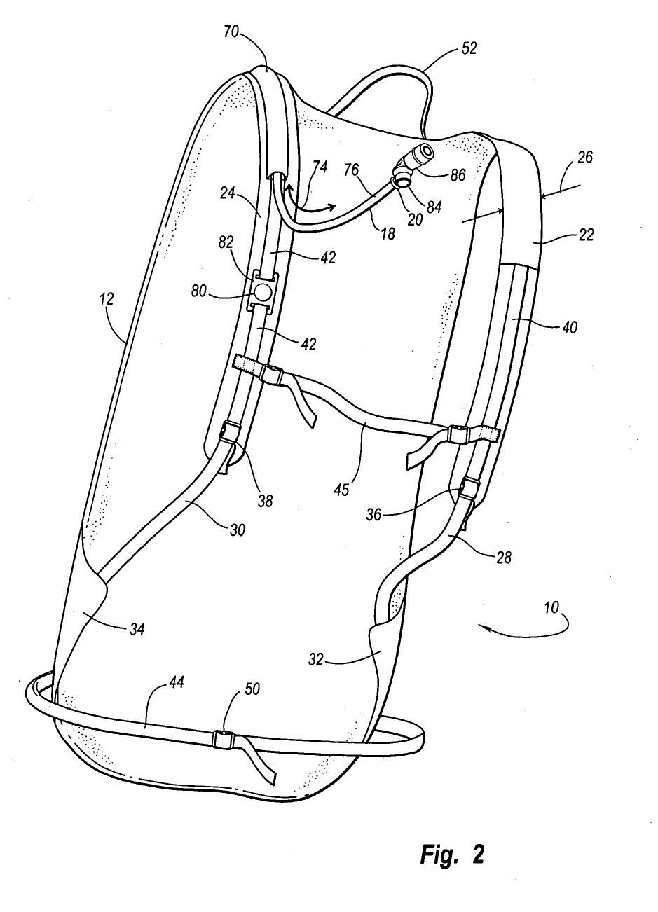

FIGS. 1 and 2 depict a hydration system 10 which includes a support system which is here shown as a pack 12, container means which is here depicted as a bladder 14 for containing a liquid 16 therein, transmission means here shown as a discharge tube 18 which is threaded through the pack 12 and a bite valve 20. While the hydration system 10 here discussed includes or is in the form of a pack 12, which is also called a back pack, it may be in a wide variety of forms, such as a hip type or lumbar type hydration pack. Any hydration system or apparatus will be suitable so long as it has a front portion or structure associated with the system or apparatus to which the bite valve 20 attaches as discussed hereinafter and a container means to retain the liquid that is dispensed through the transmission means for consumption by the user.

While the user is not illustrated or depicted, the typical user is a human to whom the hydration system attaches. However, it is within contemplation that the hydration system 10 could be attached to different animals who may be trained to operate a bite valve which may be reconfigured for use by an animal.

The pack 12 of FIG. 1 is in effect a kind of back pack for use by humans or possibly primates. It has a left shoulder support 22 and a right shoulder support 24. The left shoulder support 22 and the right shoulder support 24 each are sized to extend over the shoulders and down long the chest area toward the waist of a human. The left shoulder strap has a width 26 and has a thickness to provide for a more comfortable fit with the shoulder of the user. A left return strap 28 and a right return strap 30 are each attached to a left and right gusset 32 and 34 respectively to extend forwardly and toward the left return support 22 and right return support 24 to connect with buckles 36 and 38 for further connection to left shoulder strap 40 and right shoulder strap 42. The left shoulder strap 40 and right shoulder strap 42 are positioned centrally on the left shoulder support 22 and right shoulder support 24 respectively and transmit the load or weight of the pack 12 to the user's shoulders. Variations of shoulder supports and shoulder supports may be used so long as they function to support or connect the pack 12 or a comparable structure to the user and provide a front portion to which the bite valve may be attached as set forth hereinafter.

In FIGS. 1 and 2, a waist retainer 44 is optional but preferred and is shown attached by any suitable means to the left side of the pack 12 such as by sewing. A strengthener 48 is shown to which the waist retainer 44 is attached. Other forms of connectors can be used including buckles, snaps, D-ring connectors and the like. The waist retainer 44 is sized to extend around the body of the user to connect to the right side of the pack 12 and as here shown to a strengthener 48. The waist retainer 44 may have a buckle 50 positioned for access by the user to secure the waist retainer 44 about the body proximate the waist. The buckle 50 may allow the user to adjust the effective length of the waist retainer 44 to provide for a better or more suitable fit.

The pack 12 of FIGS. 1 and 2 also has a handle 52 positioned for grasping by the user and as a ring for the user to hang the pack 12 on a hook or similar protrusion. That is, the user may wish to hang the pack 12 in a closet or, when in use, on a convenient tree limb or outcropping for storage or to suspend at a height to assist in use by providing a better height to increase the discharge pressure of the liquid 16. The pack 12 also has straps 54 secured to the back surface 56 which can be used to affix other accessories as desired by the user.

The pack 12 also includes a chest strap 45 that is optional but preferred, which attaches by suitable clips or connectors to and extends between the left strap 40 and the right strap 42 to hold the left shoulder support 22 and the right shoulder support 44 in alignment and hold them in place.

The bladder 14 is here shown in cut-away. It is positionable in the pack 12 through the zippered opening 58. Of course once in the pack 12, the bladder 14 is fully supported. Other arrangements for supporting a container means like the bladder 14 in or on the pack 12 may be used including hooks, hook and pile connectors and a pouch. The nature of the connection or retention is limited only to those that allow the container means to discharge the liquid upon demand.

As depicted in FIGS. 1 and 2, the bladder has a fill port 60 which extends through a suitable opening 61 in the back 56 of the pack 12. A cap 62 threadedly attaches to the fill port 60 to seal the liquid 16 in the interior of the bladder 14. Notably, the liquid can be added to the interior of the bladder 14 or removed through the fill port 60. A separate discharge port 64 having a barbed extension (not shown) to which the proximal end of the discharge tube 18 attaches. In FIGS. 1 and 2, the discharge tube 18 extends from the discharge port 64 through the pack 12 and into a channel 70 formed in the right shoulder support 24 to guide the discharge tube 18 to a position on the front of the user.

In FIG. 1, discharge tube 18 has a distal end 72, a length 74 and a proximal end 76. The discharge tube 18 may be any suitable size but is typically medical grade poly tubing which is flexible. It has an outside diameter of about 0.5 inches. The bite valve 20 is secured or attached to the distal end 76.

In FIG. 2, the hydration system 10 has a first element positioned on the front of the support system. A second element is associated with the bite valve 20. The first element and the second element attract one to the other.

The first element is here shown to be a first magnet 80 attached to a buckle 82. The buckle 82 is mounted to the right shoulder support 24 and more particularly the right shoulder strap 42. The second element is also a magnet 84 mounted to the housing 86 of the bite valve 20. With the bite valve 20 removed from the user's mouth and in a free position, it should fall toward the user's waist retainer 44 and proximate the buckle 82. The first magnet 80 and the second magnet 84 are selected to have a magnetic force of attraction so that the second magnet 84, when proximate the first magnet 80, moves toward and attaches to the first magnet 80 thereby placing the bite valve 20 in a stored or fixed condition and keeping the discharge tube 18 from becoming entangled with an impediment. Accordingly, a user's hands are free to concentrate on and engage in an activity, and not placing the bite valve in a stored or fixed condition when not in the user's mouth.

The magnetic force of the magnets 80 and 84 may be selected in different magnitudes (gauss) such that the magnetic force is sufficient to attract one to the other when the magnets are a pre-selected distance from each other such as 1 inch, 2 inches, 3 inches and 4 inches.

In use, the user may place the bite valve 20 in the user's mouth and by biting on the bite valve 20, causing it to go from a closed position inhibiting fluid flow to an open position to allow fluid to flow. When done, the user may remove the bite valve 20 and allow it to drop into general alignment with the buckle 82 so that the magnets attract one to the other and place the bite valve 20 in a stored position so that a user is not required to manually make the connection. Discharge tube 18 and bite valve 20 are no longer free to swing about and into contact with clothing, other people, the ground, bushes and trees and another material or become dangerously entangled in equipment such as bicycle spokes and motorcycle wheels, gas tanks and handlebars.

To replace the bite valve 20 in the user's mouth, the user need only grip the proximal end 76 of the discharge tube 18 and pull it and the bite valve 20 apart so that the user may place the valve in the user's mouth to operate the bite valve to extract the fluid 16. The fluid may be any suitable or desired fluid such as water, or a similar hydrating fluid such as sport drinks, energy drinks, juices or the like.

In FIG. 2A, buckle 82 is located at various positions on hydration system 10. In a preferred configuration, buckle 82 is located and mounted on right strap 42. In an illustrated alternate configuration, buckle 82 my be removably connected to the right return strap 30. In another illustrated alternate configuration, buckle 82 may be slidably engaged to the optional chest strap 45. It should be appreciated that any position of buckle 82 may be used, even those not illustrated, so long as the buckle 82 is positioned in a location to receive the bite valve 20 so as to place the bite valve in a stored or fixed position and the user is not required to use his/her hands to effect the engagement.

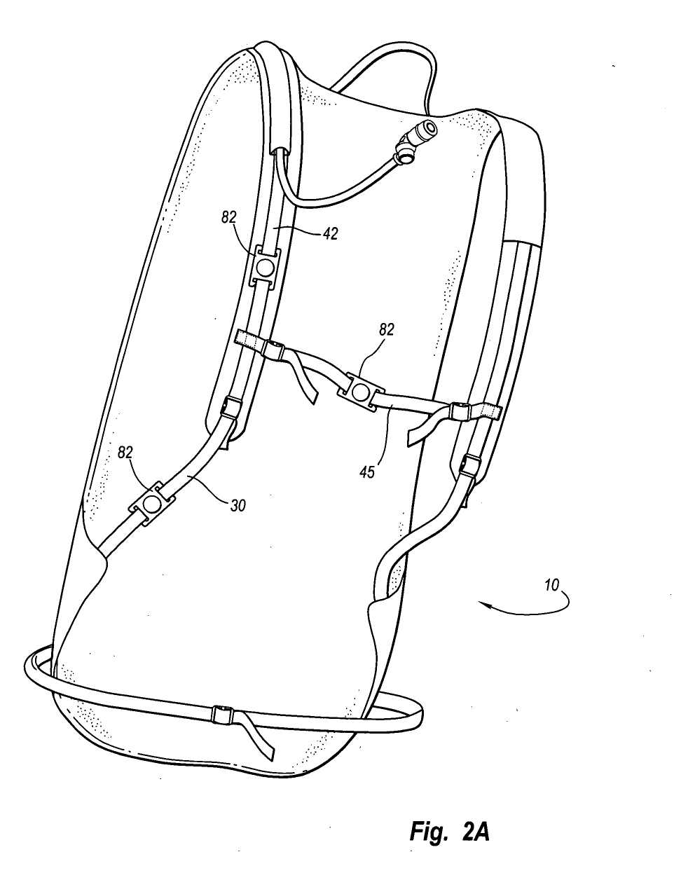

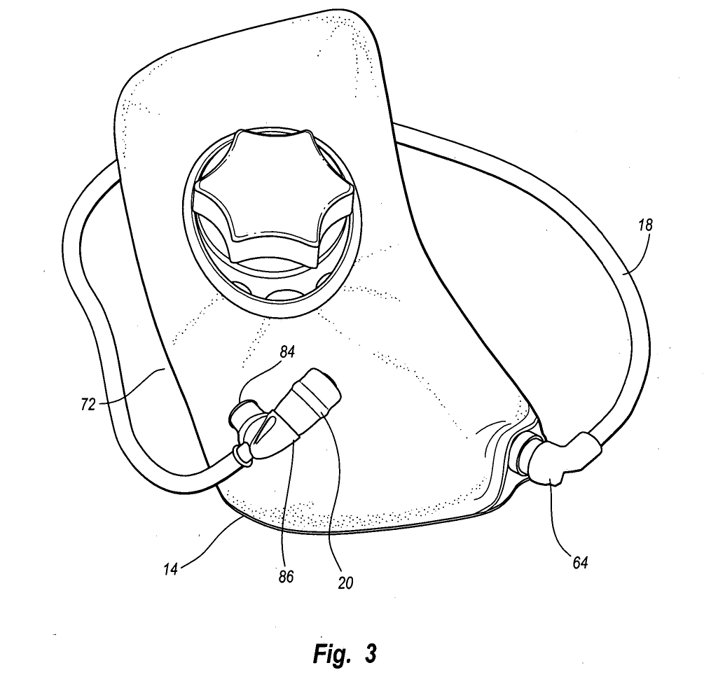

In FIG. 3, a bladder 14 is depicted removed from the pack 12. The bladder 14 has an inlet port over which cap 62 is installed. The discharge tube 18 is connected to the discharge port 64 with a bite valve 20 attached at the distal end 72 and with the second magnet 84 attached to the housing 86 of the bite valve 20.

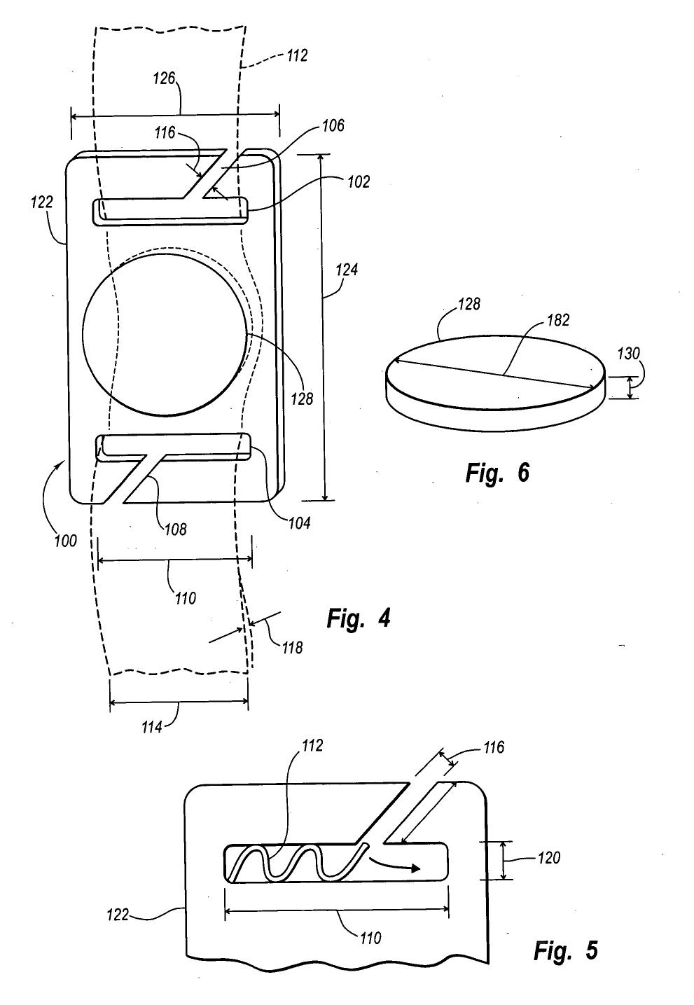

A buckle 100 is shown in FIGS. 4 and 5 with a top belt receptacle 102 and a bottom belt receptacle 104. A top slot 106 and a bottom slot 108 are provided to allow a belt or strap to be urged into the top belt receptacle 102 and the bottom belt receptacle 104. In one embodiment, the top belt receptacle 102 and the bottom belt receptacle 104 have a width 110 of about an inch and in turn is sized to receive the strap or belt 112 (shown in phantom in FIG. 4) which has a width 114 less than width 110. The strap or belt 112 is comparable to the left and right shoulder support straps 40 and 42. The top slot 106 and the bottom slot 108 each have a width 116 more than the width 118 of the strap or belt 112 to allow the strap or belt 112 to pass there through (as shown in phantom in FIG. 4). The top belt receptacle 102 and the bottom belt receptacle 104 each are sized to have a height 120 so that the strap or belt 112 may be bunched as depicted in FIG. 5 to effect the installation of the buckle 100 onto one of the left shoulder strap 42 and right shoulder strap 44. The buckle 100 also has a perimeter 122 and is sized in height 124 and width to accommodate the mounting of a first magnet 128.

In FIG. 6, the magnet 128 is shown to be cylindrical in shape with a height 130 from about 1/16 of an inch to about 3/16 of an inch and preferably ⅛ of an inch. The magnet 128 also may have a diameter 182 from about ⅜ of an inch to about ⅝ of an inch and is preferably about 0.5 inch in diameter. The magnet 128 is lightweight and formed from a magnetic rare earth material.

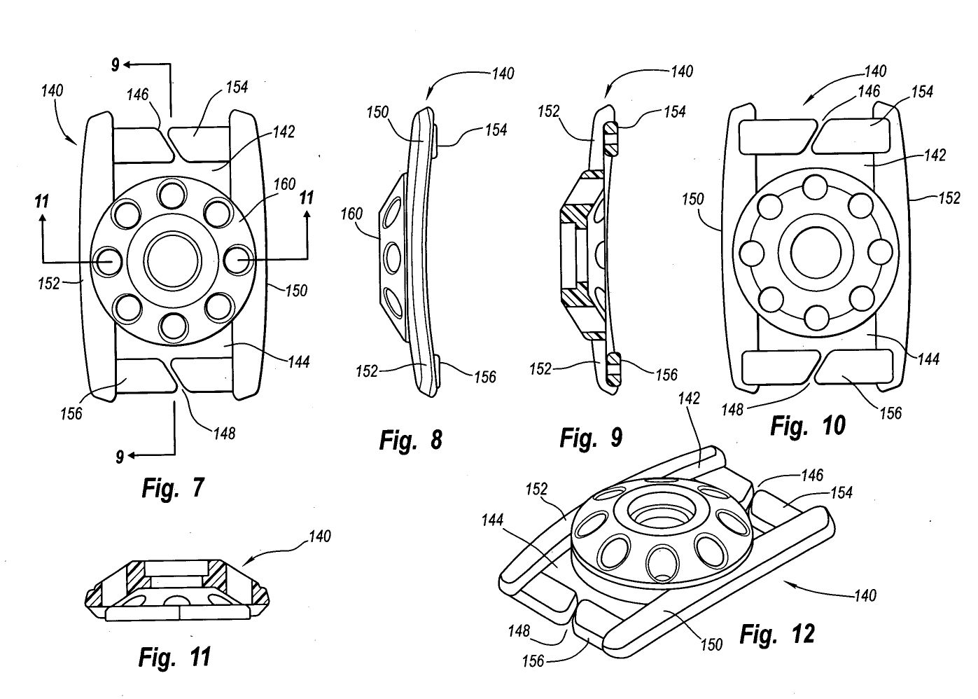

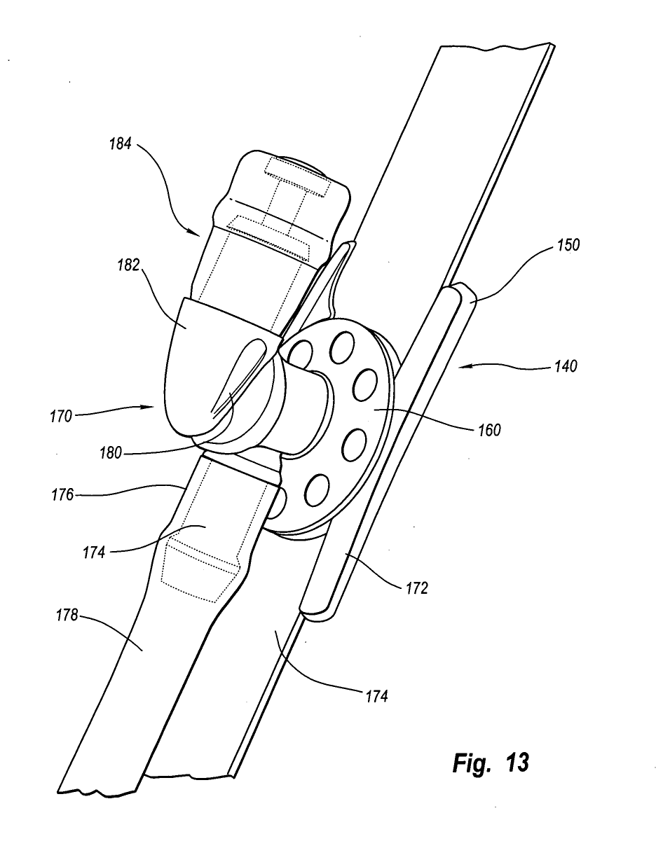

An alternate buckle 140 is depicted in FIGS. 7-12. FIG. 7 shows a front view along with FIG. 12 showing the front in perspective. FIG. 8 is a side view with FIG. 9 being a cross section along section lines 9-9. FIG. 10 is a back view with FIG. 11 being a cross section along lines 11-11 in FIG. 7. A top belt receptacle 142 and a bottom belt receptacle 144 are shown with a top slot 146 and a bottom slot 148 all configured to receive a belt or strap like the left should belt and right shoulder belt 42 and 44 respectively (FIG. 2). The buckle 140 has two side members 150 and 152 with an upper and lower threshold 154 and 156 forming in effect a race to receive the belt or strap there through. A magnet 160 is shown attached to the buckle 140 which magnet functions as a first magnet to interface and connect to a magnet attached to the bite valve 20 so that a user is not required to manually make the connection.

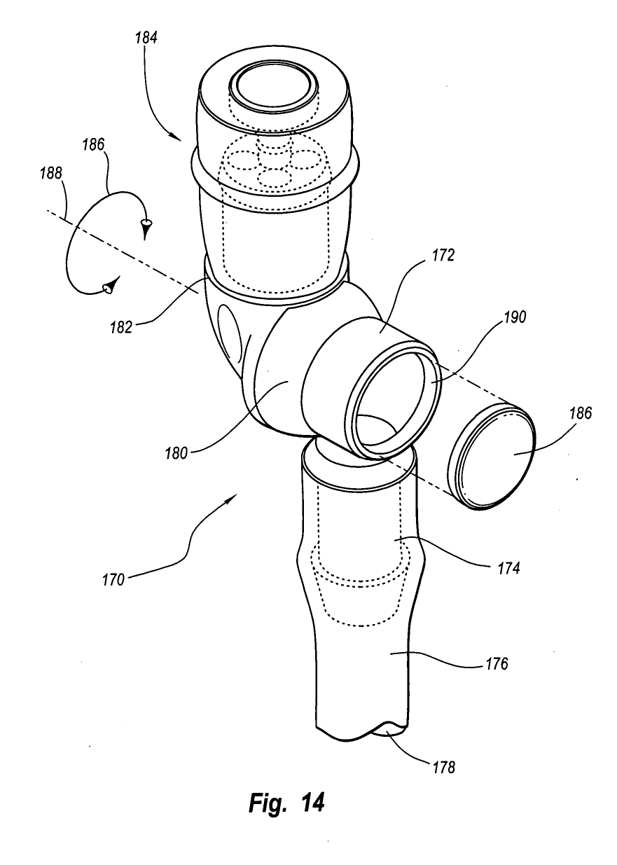

Turning to FIGS. 13 and 14, a bite valve 170 has a housing 172 from which an inlet 174 extends for connection to the distal end 176 of a discharge tube 178. The inlet is a barbed fitting sized to snugly receive the tube 178 thereover. The housing 172 has a sleeve 180 snuggly and rotatingly positioned in the housing with the discharge 182 connected to the valve portion 184 operable by the user. In the preferred embodiment, the magnet 186 is attached to bite valve 170 by firmly pressing it into a recess 190 in the housing 172. In some embodiments (not shown), the use of an adhesive may be necessary to connect the magnet 186 with a portion of the bite valve 170.

In use, the bite valve 170 of FIGS. 13 and 14 can be rotated 186 about axis 188 relative to the housing 172 to orient the valve portion 184 in a desired direction and to make it more convenient to hold the valve portion 184 in the user's mouth. Also in use, the discharge tube is sized in length so that when it is removed from the user's mouth and it hangs downwardly, it will be proximate a buckle, like buckle 100 and 140, and in turn the first magnet on the buckle will attract the magnet attached to the bite valve in order to automatically urge the bite valve into the stored position in which the first magnet and the second magnet are magnetically connected to each other.

It should be understood that other forms of bite valves may be used along with any suitable discharge tube. In addition, other magnets may be used so long as they provide sufficient force to hold the bite valve in place against the buckle or other suitable structure, so that a user is not required to use manual manipulation to bring the bite valve in close proximity with the buckle to facilitate the action of the force.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A hydration system for providing a liquid to a user upon demand, said hydration system comprising:
a support means for removable attachment to the body of a user, said support means having a front portion for positioning proximate the mouth of a user;
container means for retaining fluid there within, said container means being associated with and supported by said support system and said container having a discharge port means for transmitting said fluid out of said container means;
transmission means for transmitting said fluid from a proximal end through a length to a distal end, said proximal end being connected to said discharge port means for receiving said fluid from said discharge port means for communication through said length to said distal end;
bite valve means for positioning in the mouth of the user and configured to be operable between a first closed position inhibiting the flow of fluid there though and a second open position in which said fluid passes therethrough, said bite valve means having an inlet attached to said distal end of said transmission means to receive said fluid from said transmission means, and said bite valve having an outlet for discharging said fluid into the mouth of the user, said bite valve being shaped and sized for positioning substantially in and operated by the mouth of the user;
retaining means for removably retaining said bite valve means to said front portion, said retaining means having a securing means for attaching to a magnet, said securing means attached to said front portion, and a magnet means for attaching to said securing means, said magnet means attached to said bite valve means, said bite valve being movable between a stored position in which said securing means and said magnet means are attached and a free position in which said magnet means is detached from said securing means and said bite valve means is positionable as selected by the user.

2. The personal hydration system of claim 1 wherein said securing means comprises a magnetic material.

3. The personal hydration system of claim 1 wherein said securing means comprises a ferrite.

4. A hydration system for providing a liquid to a user upon demand, said hydration system comprising:
a support means for removable attachment to the body of a user, said support means having a front portion for positioning proximate the mouth of a user;
container means for retaining fluid there within, said container means being associated with and supported by said support system and said container having a discharge port means for transmitting said fluid out of said container means;
transmission means for transmitting said fluid from a proximal end through a length to a distal end, said proximal end being connected to said discharge port means for receiving said fluid from said discharge port means for communication through said length to said distal end;
bite valve means for positioning in the mouth of the user and configured to be operable between a first closed position inhibiting the flow of fluid there though and a second open position in which said fluid passes therethrough, said bite valve means having an inlet attached to said distal end of said transmission means to receive said fluid from said transmission means, and said bite valve having an outlet for discharging said fluid into the mouth of the user, said bite valve being shaped and sized for positioning substantially in and operated by the mouth of the user;
retaining means for removably retaining said bite valve means to said front portion, said retaining means having a securing means for attaching to a magnet, said securing means attached to said bite valve means, and a magnet means for attaching to said securing means, said magnet means attached to said front portion, said bite valve being movable between a stored position in which said securing means and said magnet means are attached and a free position in which said magnet means is detached from said securing means and said bite valve means is positionable as selected by the user.

5. The personal hydration system of claim 4 wherein said securing means comprises a magnetic material.

6. The personal hydration system of claim 4 wherein said securing means comprises a ferrite.

7. A personal hydration system for providing a liquid to a user upon demand, said hydration system comprising:
a pack for removable attachment to the body of a user, said pack having a front portion for positioning on the front of a user;
a structure for retaining fluid there within, said structure being associated with and supported by said pack, and said structure having a discharge port for transmitting said fluid out of said structure;
a discharge tube for transmitting said fluid from a proximal end through a length to a distal end, said proximal end being connected to said discharge port for receiving said fluid from said discharge port for communication through said length to said distal end;
a bite valve for positioning in the mouth of the user and configured to be operable between a first closed position inhibiting the flow of fluid there though and a second open position in which said fluid passes there through, said bite valve having an inlet attached to said distal end of said discharge tube to receive said fluid from said discharge tube, and said bite valve having an outlet for discharging said fluid into the mouth of the user, said bite valve being shaped and sized for positioning in and operated by the mouth of the user; and
a retaining system for removably retaining said bite valve to said front portion, said retaining system having a first magnetic material attached to said bite valve and a second material attached to said front portion, said second material being attracted to and removably attachable to said first magnetic material, said bite valve being movable between a stored position in which said first magnetic material and said second material are attached and a free position in which said first magnetic material is detached from said second material and said bite valve is positionable as selected by the user.

8. The personal hydration system of claim 7 wherein said second material is a second magnetic material.

9. The personal hydration system of claim 7 wherein said second material is a ferrite.

10. The personal hydration system of claim 6 wherein said pack is a back pack; and wherein said structure for retaining fluids is a bladder positioned in said back pack.

11. The personal hydration system of claim 7 wherein said first magnetic material and said second material are elected to have a magnetic field to attract one to the other when spaced apart a distance up to about 1 inch along a line normal to said first magnetic material.

12. The personal hydration system of claim 7 wherein said first magnetic material and said second material are selected to have a magnetic field to move one toward the other when spaced apart a distance of up to about 2 inches along a line normal to said first magnetic material.

13. The personal hydration system of claim 7 wherein said first magnetic material and said second material are elected to have a magnetic field to move one toward the other when spaced apart a distance of up to about 3 inches from said first magnetic material.

14. The personal hydration system of claim 7 wherein said first magnetic material and said second material are selected to have a magnetic field to move one toward the other when spaced apart a distance of up to about 4 inches away from said first magnetic material.

15. The personal hydration system of claim 7 wherein said first magnetic material and said second material are selected to be cylindrical magnets which each have a magnetic field to attract one to the other when spaced apart a distance.

16. The personal hydration system of claim 8 wherein said first magnetic material and said second magnetic material are rare earth magnets.

17. The personal hydration system of claim 16 wherein said first magnetic material and said second magnetic material are each cylindrical in shape with a diameter from about ⅜ of an inch to about ⅝ of an inch and a thickness from about 1/16 of an inch to about one fourth of an inch.

18. The personal hydration system of claim 7 wherein said length of said discharge tube is selected to position said distal end of said discharge tube and said first element proximate said second element when said second element is in said stored position, and wherein said first magnetic material and said second material are elected to have a magnetic field to attract one to the other when said bite valve is in said free position and move toward said stored position.

19. The personal hydration system of claim 7 wherein said bite valve has a housing and a sleeve sealingly and rotatably positioned in said housing, and wherein said first magnetic material is attached to said housing.

20. The personal hydration system of claim 19 wherein said sleeve includes a head having an aperture, and where in said bite valve includes a tooth assembly for positioning in the mouth of the user, said tooth assembly being inserted into said aperture of said head.

21. The personal hydration system of claim 20 wherein said housing has a fitting connected to said distal end of said discharge tube and wherein said sleeve is rotatable relative to said housing.

22. The personal hydration system of claim 7 wherein said front portion includes a strap having a length and wherein said first element includes a buckle attached to said strap, said buckle being configured to be positionable along said length of said strap.

23. The personal hydration system of claim 22 wherein said buckle includes top belt receptacle and bottom belt receptacle, said top belt receptacle and said bottom belt receptacle each being configured to receive said strap there through, and wherein said buckle includes a perimeter and a first slot extending from said perimeter to said top belt receptacle, and wherein said buckle includes a second slot extending from said perimeter to said bottom belt receptacle, said first slot and said second slot both being sized to receive said strap there through.

24. A hydration system for providing a liquid to a user upon demand, said hydration system comprising:
a back pack for removable attachment to the back of a user, said back pack having a pair of straps configured to pass from the back pack over the shoulders of the user over the chest of the user for reconnection to said back pack;
a bladder for retaining fluid, said bladder being associated with and supported by said back pack, and said bladder having a fill-port for transmitting fluid into and out of said bladder and a discharge port for transmitting said fluid out of said bladder;
a discharge tube for transmitting said fluid from a proximal end through a length to a distal end, said proximal end being connected to said discharge port for receiving said fluid from said discharge port for communication through said length to said distal end, said discharge tube being sized to extend from said bladder over a shoulder of a user;
a bite valve for positioning in the mouth of the user and configured to be operable between a first closed position inhibiting the flow of fluid there though and a second open position in which said fluid passes there through, said bite valve having an inlet attached to said distal end of said discharge tube to receive said fluid from said discharge tube, and said bite valve having an outlet for discharging said fluid into the mouth of the user; and
a retaining system for removably retaining said bite valve to said front portion, said retaining means having a buckle with a first magnetic material attached thereto and a second material attached to said bite valve, said buckle being attached to one of said pair of straps at a location to attract said bite valve in said free position, said first magnetic material and said second material having a magnetic attraction so that said bite valve is attracted toward said buckle when proximate thereto, said bite valve being movable between a stored position in which said first magnetic material and said second material are attached and a free position in which said second material is manually detached from said first magnetic material.

25. The hydration system of claim 24 wherein said first magnetic material and said second material are selected to have a magnetic attraction of sufficient strength to cause said bite valve to attach to said buckle whenever said bite valve is in said free position.

26. The hydration system of claim 24 wherein said second material comprises a second magnetic material.

27. The personal hydration system of claim 24 wherein said first magnetic material is a rare earth magnet.

28. A retaining system for removably retaining a bite valve of a personal hydration system having a front portion, said retaining system comprising:
a first magnetic material attached to said front portion;
a second magnetic material attached to said bite valve; and
wherein said first magnetic material and said second magnetic material are sized and selected to have a magnetic force in combination that said bite valve is attracted toward said first magnetic material when moving in proximity of said first magnetic material, said bite valve and said second magnetic material being movable between a stored position in which said first magnetic material and said second magnetic material are attached and a free position in which said second magnetic material is manually detached from said first element by said user.

29. The personal hydration system of claim 28 wherein said first magnetic material and said second magnetic material are elected to have a magnetic field to move one toward the other when spaced apart a distance of up to about 3 inches from said first magnetic material.

30. The personal hydration system of claim 28 wherein said first magnetic material is a rare earth magnet.

31. A method of removably retaining a bite valve of a personal hydration system in a secure position, said method comprising:
providing a pack for removable attachment to the body of a user, said pack having a front portion for positioning on the front of a user;
providing a structure for retaining fluid there within, said structure being associated with and supported by said pack, and said structure having a discharge port for transmitting said fluid out of said structure;
providing a transmission means for transmitting said fluid from a proximal end through a length to a distal end, said proximal end being connected to said discharge port means for receiving said fluid from said discharge port means for communication through said length to said distal end;
providing bite valve for positioning in the mouth of the user and configured to be operable between a first closed position inhibiting the flow of fluid there though and a second open position in which said fluid passes therethrough, said bite valve having an inlet attached to said distal end of said transmission means to receive said fluid from said transmission means, and said bite valve having an outlet for discharging said fluid into the mouth of the user, said bite valve being shaped and sized for positioning substantially in and operated by the mouth of the user;
providing a retaining system for removably retaining said bite valve means to said front portion, said retaining system having a first material attached to said front portion and a second magnetic material attached to said bite valve means, said bite valve being movable between a stored position in which said first material and said second magnetic material are attached and a free position in which said second magnetic material is detached from said first material and said bite valve means is positionable as selected by the user.
